(19) United States
(12) Patent Application Publication
(10) Pub. No.: US 2003/0037192 A1
(43) Pub. Date: Feb. 20, 2003

(54) Universal point-of-sale (POS) device with interchangeable communication modules

(76) Inventor: Rolf G. Engstrom, Irvine, CA (US)

Correspondence Address: EIIC K SATERMO, P O BOX 19099, IRVINE, CA, 92623

(21) Appl. No.: 09/929,925

(22) Filed: Aug. 15, 2001

(51) Int. Cl. G06F 13/12

(52) U.S. Cl. 710/72

(57) ABSTRACT

A point-of-sale (POS) device includes a main body and a communication module. The main body includes a main circuit for performing point-of-sale functions and an interface having a port in communication with the main circuit and a physical connection apparatus. The communication module includes a modem circuit for operating in accordance with a modem protocol and an interface. The interface of the communication module has a port in communication with the modem circuit and for connecting to the port of the interface of the main body, and a physical connection apparatus for releasably engaging with the physical connection apparatus of the interface of the main body. The interface of the communication module is configured to be complementary with the interface of the main body such that when the physical connection apparatus are engaged, the ports are connected.

### BACKGROUND OF THE INVENTION

1. Field of the Invention

The present invention relates to devices that communicate data and, more particularly, to point-of-sale (POS) devices with a modem for communicating data.

2. Description of Related Technology

Point-of-sale (POS) devices have become ubiquitous in the retail industry. Nearly every retail establishment has a POS device or terminal at the cash register so that electronic transactions may take place. POS devices enable electronic transactions by swiping a credit or debit card, reading account information stored on the magnetic strip of the card, communicating with a remote host system or automated clearing house, and receiving verification that funds are available for the amount of the purchase. Conventional POS terminals may include any number of additional devices, such as a keypad, a printer unit, a signature capture unit, a fingerprint unit, and so on.

As mentioned, POS terminals need to communicate with a remote system during an electronic transaction. The communication may take place on a telephone line or wirelessly. In either case, there are any number of communication protocols in use today that may be employed for this purpose. For example, there are a number of modem protocols based on technologies such as CDPD, Motient, Mobitex, GSM, and CDMA. Alternatively, infrared, Bluetooth, and other radio frequency (RF) protocols are used to communicate data. Still other communication technologies included GPS, Ethernet LAN, IEEE 802.11 b, and IEEE 802.11 DSSS WLAN.

This wide variety of communication protocols leads to one of the drawbacks in the art of POS devices, namely, dedicated POS devices need to be manufactured for each of the communication protocols in use. At the manufacturing end, this entails large installations and dedicated assembly lines for each protocol-dependent POS device. In addition, correspondingly large warehousing facilities need to be maintained for adequate inventory.

In view of the foregoing, there is a need in the art for a universal POS device that enables communication in any desired protocol while reducing the manufacturing costs and complexity.

### SUMMARY OF THE INVENTION

The present invention provides a universal point-of-sale (POS) device that has a single main body that is configured so that a plurality of interchangeable communication modules are attachable thereto and detachable therefrom. Each of the communication modules is configured to communicate data in accordance with a respect protocol. Accordingly, all retail establishments purchase the same main body, and then select one of the communication modules to configure the main body to communicate in accordance with a desired protocol. Accordingly, from a manufacturing standpoint, the POS device of the present invention is highly favorable in that only a single universal main POS body needs to be fabricated in conjunction with a plurality of the less complicated and less expensive communication modules.

According to one aspect of the invention, a point-of-sale (POS) device includes a main body and a communication module. The main body includes a main circuit for performing point-of-sale functions and an interface having a port in communication with the main circuit and a physical connection apparatus. The communication module includes a modem circuit for operating in accordance with a modem protocol and an interface. The interface of the communication module has a port in communication with the modem circuit and for connecting to the port of the interface of the main body, and a physical connection apparatus for releasably engaging with the physical connection apparatus of the interface of the main body. The interface of the communication module is configured to be complementary with the interface of the main body such that when the physical connection apparatus are engaged, the ports are connected.

As mentioned, one of the advantages of the invention is that a plurality of communication modules may be manufactured, each with a modem circuit operating in accordance with a respective modem protocol, with each communication module being compatible with a single universal main body.

According to a preferred embodiment, the physical connection apparatus of the main body includes a pair of slots, and the physical connection apparatus of the communication module includes a pair of rails configured to slidingly engage with the rails. Alternatively, the physical engagement apparatus of the main body may include one or more sockets, and the physical interface apparatus of the communication module may include a respective number of pins configured to releasably engage with the sockets when the rails are engaged with the slots. Accordingly, the physical interface apparatus is configured to align the ports, for example, RS-232 ports, for effective communication with engaged.

Additional aspects, features, and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a perspective view of an exemplary universal point-of-sale (POS) device configured in accordance with the present invention, which POS device is configured so that a communication module with a particular modem protocol is detachable and connectable thereto;

FIG. 2 is a fragmentary perspective view of a universal POS device with an interchangeable communication module, particularly illustrating a physical interface of a main body of the POS device and that of a communication module;

FIG. 3 is a fragmentary perspective view of a universal POS device with a plurality of interchangeable communication modules;

FIG. 4 is a block diagram of an exemplary communication module configured in accordance with the present invention;

FIG. 5 is a block diagram of an exemplary universal POS device in accordance with the present invention;

FIG. 6 is a fragmentary perspective view of a universal POS device with an interchangeable communication module, particularly illustrating an alternative embodiment of a physical interface of a main body and that of a communication module; and

FIG. 7 is a perspective view of the communication module of FIG. 6.

### DETAILED DESCRIPTION OF THE INVENTION

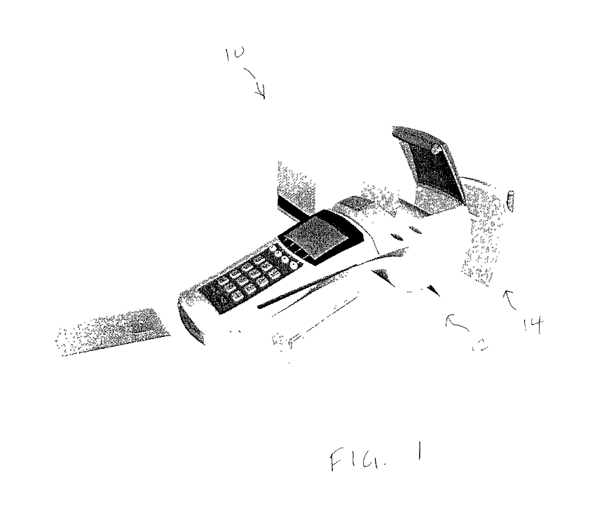

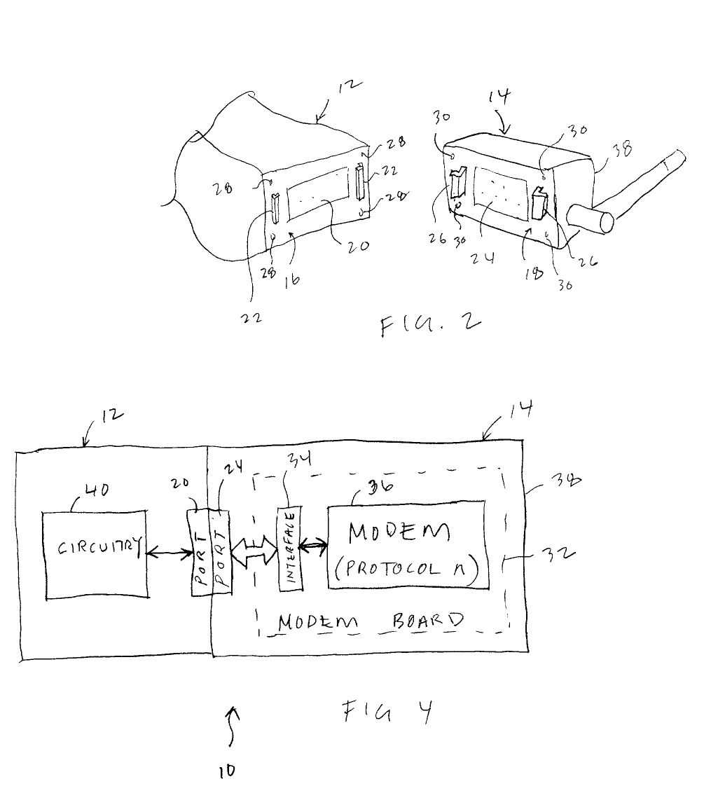

Referring more particularly to the drawings, an exemplary embodiment of a universal point-of-sale (POS) device in accordance with the principles of the present invention is illustrated in FIG. 1 and indicated with reference numeral 10. Exemplary POS device 10 generally includes a main body 12 and a communication module 14. With additional reference to FIG. 2, the main body 12 and the communication module 14 each have a physical interface 16 and 18, respectively, which are complementarily configured so that the communication module 14 is releasably attachable to the main body 12.

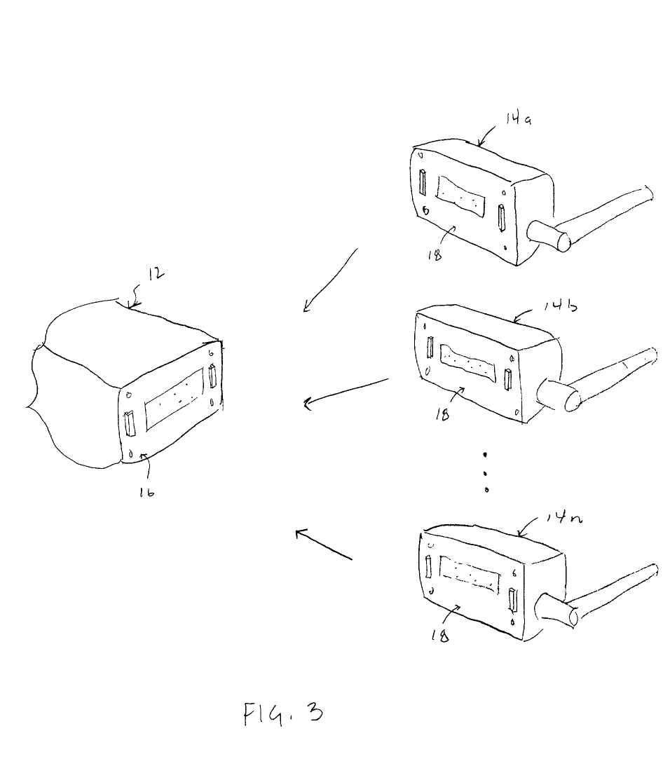

More specifically, in accordance with a preferred embodiment of the present invention, the main body 12 of the universal POS device 10 is configured so that a plurality of interchangeable communication modules 14a, 14b, . . . , 14n are attachable to and detachable from the main body 12 as shown in FIG. 3. Accordingly, the physical interface 18 of each module 14 is configured substantially identically to be complementary with interface 16 of the main body 12, while the modem circuitry thereof is unique to each module 14, which is discussed in more detail below.

In accordance with a preferred embodiment as shown in FIG. 2, the physical interface 16 of exemplary main body 12 may include a port 20 and physical connection apparatus such as slots 22, and the physical interface 18 of each communication module 14 may include a port 24 and complementary physical connection apparatus such as rails 26. The slots 22 and the rails 26 may be longitudinally configured so that the rails 26 slidingly engage with the slots 22. The physical engagement apparatus of interface 16 may also include one or more sockets 28 and 18 may include one or more sockets 28, and the physical interface apparatus of interfaces 18 may include a respective number of pins 30. The sockets 28 and the pins 30 are preferably configured to releasably retain the communication module 14 on the main body 12 when the rails 26 are fully engaged or received within the slots 22. The port 20 and the ports 24 may be configured as any type of known data port, such as RS-232 ports or TTL ports.

In accordance with the present invention, a single universal main body 14 is compatible with a plurality of communication modules 14a-14n each configured in accordance with a respective modem protocol. More specifically, as shown in FIG. 4, each communication module 14 includes a modem board 32 with an interface 34 connected to the port 24 and a modem circuit 36 connected to the interface 34. The modem circuit 36 is configured to operate in accordance with a particular modem protocol, for example, CDPD, Motient, Mobitex, GSM, GPRS, CDMA, and 1xRTT, which protocols are known in the art. More specifically, with additional reference to FIG. 3, the modem circuit 36 of each of the modules 14 is configured in accordance with a respective modem protocol so that the POS device 10 may be user configured to operate in accordance with a desired modem protocol.

In this regard, to configure the POS device 10 to communicate data in accordance with a desired protocol, one of the communication modules 14 is selected and connected to the main body 12. If it is preferable to change the communication protocol, then the module 14 may be disconnected from the main body 12, with another module 14 being selected and then connected to the main body 12. Accordingly, depending upon the type of installation, a user may customize the POS device 10 to operate in accordance with a desired modem protocol.

In addition, each communication module 14a-14n includes a housing 38. Preferably, the housing 38 of each module 14 is configured to accommodate a single one of the protocol-specific modem boards 32. Also, to maintain uniformity between the communication modules 14, it may be preferable to configure the housing 38 of each communication module 14a-14n identically.

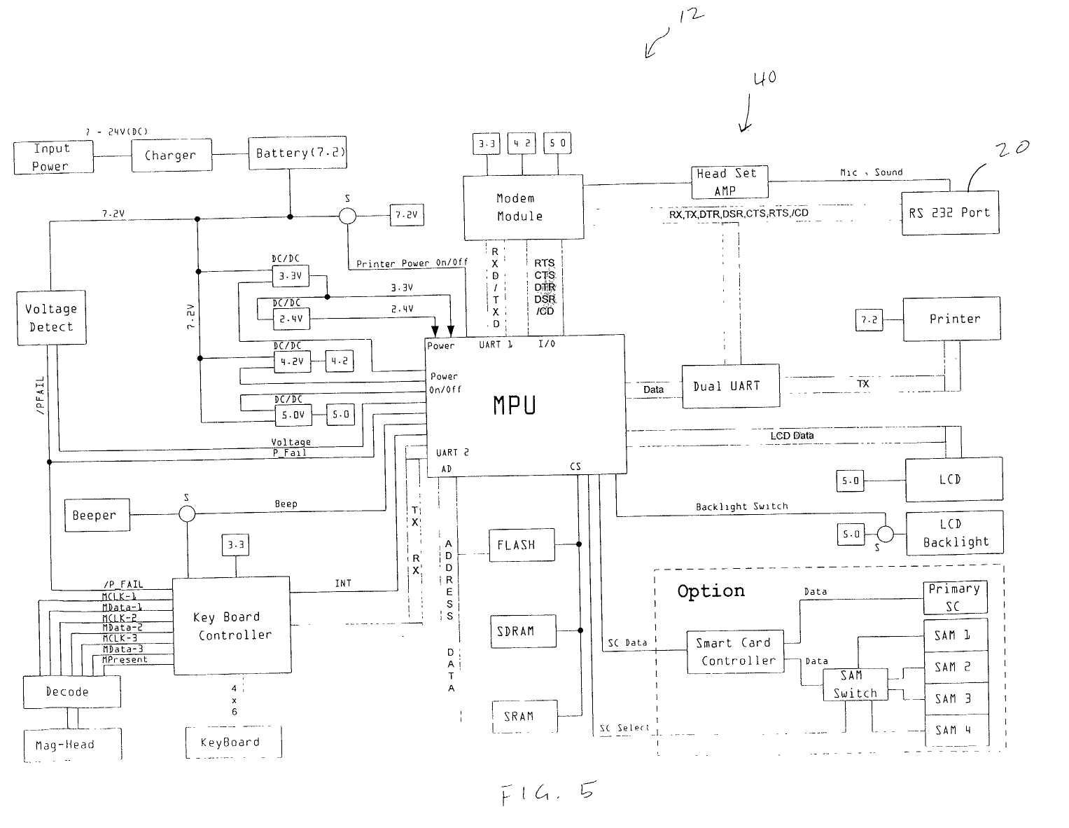

Referencing FIG. 5, a block diagram of circuitry 40 for the main body 12 of the universal POS device 10 of the invention is illustrated. As shown, the main circuitry 40 includes the single port 20 for connecting with the port 24 of each communication module 14. In the preferred embodiment shown in the drawings, the main circuitry 40 is configured to carry out functions necessary for performing point-of-sale transactions, as known in the art.

The present invention has been heretofore described in reference to a preferred embodiment of a POS device. However, the principles of the invention are applicable to any device with a removable communication module. For example, referencing FIG. 4, the main body 12 and circuitry 40 may be configured as any type of communication device, with module 14 configured as a communication module that is removable from the main body 12. For example, exemplary module 14 may be configured to communicate date in accordance with any known communication technology, such as Ethernet protocol, cellular, radio frequency such as Blue Tooth, and so on. In other words, exemplary module 14 may be configured as a communication module in which the modem circuitry 36 is configured to transmit and receive data in accordance with any type of technology. Accordingly, while a preferred embodiment of the invention encompasses modem technology for the module 14, the universal communication device 10 may be configured as any type of communication device with a removable communication module 14.

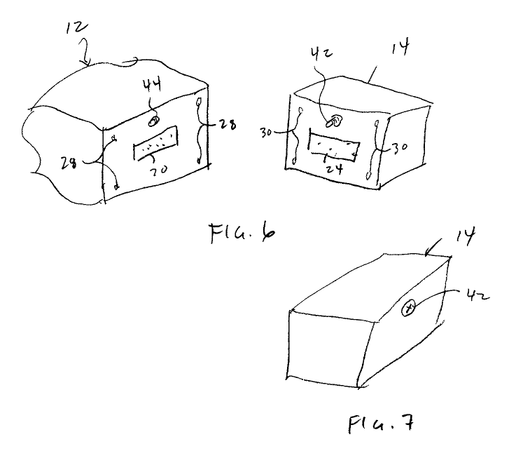

Those skilled in the art will understand that the preceding exemplary embodiments of the present invention provide the foundation for numerous alternatives and modifications thereto. For example, with reference to FIGS. 6 and 7, the physical connection apparatus of the module 14 may include a screw 42 and the physical connection apparatus of the main body 12 may include a corresponding hole 44. Accordingly, to connect the module 14 to the body 12, the pins 30 may be coupled with the sockets 28, thereby aligning the connectors of the ports 20 and 24, with the screw 42 then being engaged with the hole 44. These other modifications are also within the scope of the present invention such that the present invention is not limited to that precisely as shown and described in the present invention.

What is claimed is:

1. A point-of-sale (POS) device with a removable communication module, the POS device comprising:
a main body including a main circuit for performing point-of-sale functions and an interface having a port in communication with the main circuit and a physical connection apparatus; and
a communication module including a modem circuit for operating in accordance with a modem protocol and an interface having:
a port in communication with the modem circuit and for connecting to the port of the interface of the main body; and
a physical connection apparatus for releasably engaging with the physical connection apparatus of the interface of the main body;
the interface of the communication module configured to be complementary with the interface of the main body such that when the physical connection apparatus are engaged, the ports are connected.

2. A POS device as claimed in claim 1 wherein the physical connection apparatus of the main body includes a pair of slots, and the physical connection apparatus of the communication module includes a pair of rails configured to slidingly engage with the rails.

3. A POS device as claimed in claim 2 wherein the physical engagement apparatus of the main body includes at least one socket, and the physical interface apparatus of the communication module includes a respective number of pins configured to releasably engage with the sockets when the rails are engaged with the slots.

4. A POS device as claimed in claim 1 wherein each of the ports is a RS-232 port.

5. A POS device as claimed in claim 1 wherein the modem circuitry is configured to operate in accordance with a modem protocol selected from a group consisting of CDPD, Motient, Mobitex, GSM, GPRS, CDMA, and 1xRTT.

6. A POS device as claimed in claim 1 further comprising a plurality of the communication modules;
the modem circuit of each of the communication modules being configured to operate in accordance with a respective modem protocol; and
each of the communication modules being releasably connectable to the main body.

7. A POS device as claimed in claim 6 wherein the interfaces of the communication modules are configured substantially identically.

8. A POS device as claimed in claim 6 wherein each of the communication modules includes a housing;
the housings being configured substantially identically.

9. A communication device with a removable communication module, the device comprising:
a main body including a main circuit and an interface having a port in communication with the main circuit and a physical connection apparatus; and
a communication module including a communication circuit configured to transmit and receive data and an interface having:
a port connected to the communication circuit and for releasably connecting to the port of the interface of the main body; and
a physical connection apparatus for releasably engaging with the physical connection apparatus of the interface of the main body;
the interface of the communication module configured to be complementary with the interface of the main body such that when the physical connection apparatus are engaged, the ports are connected.

10. A method for configuring a point-of-sale (POS) device to transmit data in accordance with a modem protocol, the method comprising:
a) providing a POS main body including a main circuit for performing point-of-sale functions and an interface having a port in communication with the main circuit and a physical connection apparatus; and
b) providing a communication module including a modem circuit for operating in accordance with a modem protocol and an interface having:
a port in communication with the modem circuit and for connecting to the port of the interface of the main body; and
a physical connection apparatus for releasably engaging with the physical connection apparatus of the interface of the main body;
c) connecting the communication module to the main body by engaging the physical connection apparatus together so that the ports are connected to enable data communication therebetween.

11. A method as claimed in claim 10 further comprising:
d) disconnecting the communication module from the main body by disengaging the physical connection apparatus.

12. A method as claimed in claim 11 further comprising:
repeating steps (c) and (d).

13. A method as claimed in claim 10:
wherein step (b) comprises providing a plurality of communication modules with the modem circuit of each being configured to operate in accordance with a respective modem protocol;
further comprising selecting one of the communication modules; and
wherein step (c) comprises connecting the selected communication module to the main body.

14. A method as claimed in claim 13 further comprising:
d) disconnecting the selected communication module from the main body;
e) selecting another one of the communication modules; and
f) connecting the selected communication module.

15. A method as claimed in claim 14 further comprising:
repeating steps (d) to (f).
